(19) United States
(12) Patent Application Publication
(10) Pub. No.: US 2013/0015950 A1
(43) Pub. Date: Jan. 17, 2013

(54) CONTAINER, SYSTEM AND METHOD FOR GOODS TRANSPORT

(71) Applicant: Bastiaan Cornelis Wip, Uithoorn (NL)

(72) Inventor: Bastiaan Cornelis Wip, Uithoorn (NL)

(73) Assignee: ACISS INTERNATIONAL B.V., Amsterdam (NL)

(21) Appl. No.: 13/576,470

(22) PCT Filed: Feb. 4, 2011
(86) PCT No.: PCT/NL2011/050084

§ 371 Date: Sep. 20, 2012

(30) Foreign Application Priority Data
Feb. 4, 2010 (NL) 2004192

(51) Int. Cl. G06F 7/04

(52) U.S. Cl. 340/5.54; 340/5.51; 340/5.7

(57) ABSTRACT

The invention relates to a container for goods transport, comprising walls, enclosing a storage space for the goods, a closable entrance to the storage space, such as a door, a lock, for locking respectively unlocking the entrance to the storage space, means for reading a global destination position for the container in a database, means for determining an actual global position of the container, a controller configured to enable unlocking the lock based on at least the global destination position and the actual global position. In an embodiment, the controller is configured to enable unlocking the lock when the actual global position is within a predetermined range of the predetermined global position. The invention further relates to a system and method using the above container.

### FIELD OF THE INVENTION

The present invention relates to a container, a system and a method for goods transport. More in particular, the invention relates to a lockable container for theft-prevention and prevention of opening of containers during goods transport, as well as a system and method using said container.

### BACKGROUND OF THE INVENTION

A system for enabling unlocking a container at a predetermined destination address is known from the US Patent application US 2003/0179073. Herein, a portable reader, such as a PDA, is used for determining a GPS location, which is then loaded into a lock processor that determines whether or not a container may be unlocked at said address.

This system however has several disadvantages. A separate and compatible PDA device is required and thus has to be available to be able to open the container. If such device is present, it may easily be manipulated to provide incorrect location data, upon which the container may be opened at an incorrect location. Furthermore, the required lock processor is a relatively expensive and fragile component to be incorporated in a container. It is therefore a goal to provide a container, a system and a method for goods transport that overcome at least part of the above disadvantages.

### SUMMARY OF THE INVENTION

The present invention thereto provides a container for goods transport, comprising walls, enclosing a storage space for the goods, a closable entrance to the storage space, such as a door, a lock, for locking, respectively unlocking the entrance to the storage space, means for reading a global destination position for the container in a database, means for determining an actual global position of the container, and a controller configured to enable unlocking the lock based on at least the global destination position and the actual global position.

Since the container is provided with means for determining an actual global position of the container, which can for example be a GPS and/or a GPRS module, no external device is required anymore, and the possibility to use manipulated global position information is reduced.

The global destination position may be stored in a memory of the container, but advantageously, the container retrieves this information from a central storage such as a database at a moment when it is desired to open and thereto unlock the container. This way, the information regarding the global destination position can be kept current at all times, and even be changed during transport of the container when circumstances require so.

The controller for the lock can for example be programmable and be configured to unlock the lock upon receiving a specific command, or when specific conditions are met. An example of such specific conditions is to unlock the lock when the actual global position is within a predetermined range of the predetermined global position (and within specific time window).

When using a GPS system in a container, it is a goal to save battery power, in order to keep power during long distance shipments, which may take weeks or even months. For that reason, the GPS may be configured to update its global position only every once in a while, since the updating action is one of the energy consuming processes. According to the invention, the update-frequency may depend on a calculated distance between the destination and the last measured actual position. In that case, the update frequency is increased when the container reaches its destination. For example, this frequency may be once every 60 minutes when the distance is more than 100 kilometers. Once every 20 minutes between 100 and 50 kilometers, once every 10 minutes between 50 and 10 kilometers, every minute between 10 and 5 kilometers, and continuous when the distance is less than 5 kilometers.

Especially when the delivery location is within a metal or concrete building, it may be impossible to retrieve a GPS data signal. In that case the container may be configured to automatically switch over to . . . , in order to retrieve its actual location.

In addition, the container may comprise input means for an access code, such as a User Code (a user ID) which may be used in combination with a password such as a PIN code. In that case, the controller can further be configured for enabling locking and unlocking the lock when an access code entered on the input means matches a code stored in the data storage means. Herewith, opening of the container is not only restricted to a specific location, but also to a specific (authorised) person, who—in case of a password or PIN code—needs to identify himself or herself Such a user ID (also referred to as user credentials) can for example be coupled upfront to a specific location, so that a person is only allowed to open the container at that specific location. It is also possible to distinguish between user ID's that are bound to a location, and others that are not. More specifically, various types of users may be distinguished, such as (employees of the) recipient, or customs (employees). It is also thinkable that a group of recipients is defined, or that a specific recipient (from a group of recipients, for example one employee from a number of employees of a shop) is defined during transport of the container, or that the exact recipient is changed during transport.

To enable verification of dynamically assigned employees, a coupling with a personnel system or an addressbook of a supposed receiving instance may be made. Presence in such an address book (or directory, such as Open Directory or Active Directory) may also be an extra condition for the container to permit opening thereof.

Another option is to provide user credentials that can be used only one time, for example for use in e-commerce.

The password can be issued to the user upfront as well, but one may also choose to provide the user therewith only after (confirmation of) arrival of the container at the predetermined global destination position.

For entering a user ID or a PIN code, the input means can for example comprise a keypad, a receiver for SMS or like messages, or means for receiving data through the internet.

By these or other means, the controller may also be configured to receive a request to enable unlocking the lock. This request may then be sent from a mobile device of a recipient who may in addition be required to enter a user ID and a PIN code, or the request me be sent by the sender of the message, either from a mobile communication device, or from a dedicated website.

The invention thereto further relates to a system for transferring goods, comprising at least one container, a server (computer), accessible via the internet, hosting a database for storing at least an ID for each container, and a global destination position for each container.

The database may further comprise an overview of recipient coupled to a global destination position, or coupled to a specific global destination position. In that case, a sender can be sure that a container can only be opened by the intended recipient, and at the intended location.

For example for customs reasons, the database may further comprise a recipient type coupled to a recipient. Possible types of recipients can then be “normal” or “actual” recipients, customs personnel, or employees of a transport company, such as an aircraft company.

In order to provide senders with a tool to enter details regarding the destination of a container, or to change authorisations or other details, the server preferably comprises a web-interface, accessible for senders of containers, for adding or changing data in the database. The web-interface may further be arranged to track and trace the container, either for senders or for receivers or for both.

The container may yet further be configured to log circumstancial parameters, such as temperature, moisture, and/or shocks the container undergoes during transport. It is further possible to store threshold values in logic provided within the container, and disable unlocking of the container when these thresholds have been exceeded. The container or the goods within the container may be marked so that they are visually identifiable after the parameter thresholds have been exceeded. Such indication may for example be a red indicator light visible on the exterior of the container. Specific details can be read from logs kept by the container, or sent to a database by a server.

Further logs may be present containing information on the persons and locations where the container was openend. These logs may as well be sent to a central database and be accessed therefrom.

The container may further be configured to exchange information by SMS or NFC with authenticated phones.

In a further embodiment, the server may be configured for receiving a request from a recipient for opening a container, and for forwarding said request to the controller of the respective container.

### BRIEF DESCRIPTION OF THE DRAWINGS

The invention will now be elucidated into more detail with reference to the following figures, wherein:

FIG. 1 shows an open request validation flow chart for container according to the present invention;

FIGS. 2a-2c show a process flow of opening a container according to the invention.

FIG. 3 shows a high-level data process flowchart according to the invention; and
FIGS. 4a-4c show a high level process flow according to the invention.

FIG. 5 shows a process flow of a container connecting to a central server;

FIG. 6 shows a process flow of a container checking for updates during transit;

FIG. 7 shows a configuration wherein a directory server or active directory is used.

### DETAILED DESCRIPTION

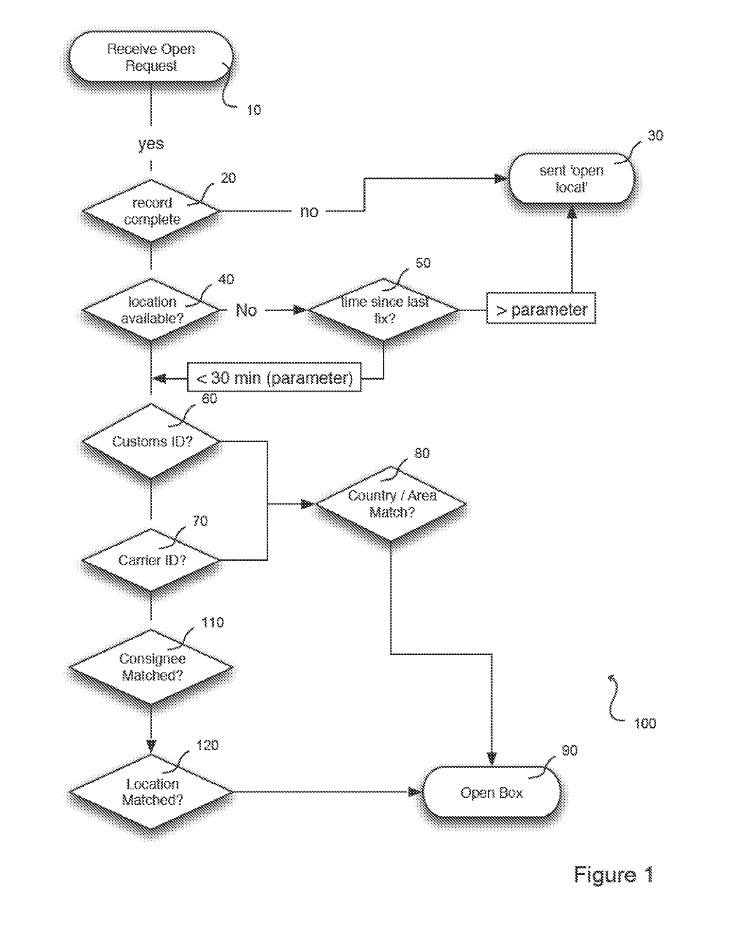

In FIG. 1, a flow chart 100 is shown. For opening the container, an “Open Request” 10 should be received first, from a recipient of the container. The request may be entered on a keypad present on the container, or for example be sent to the container by means of a SMS.

After receiving the “open request”, at the server side, a check 20 is performed whether a complete record is present for opening the container.

If the record is found to be incomplete, no server side validation can take place. A code will be provided for these cases, that can be downloaded from the website. Validation of this code is performed locally.

If the record is complete, a check 40 is performed to find out if the location is available If not, the time since the last fix is determined 50 and compared with a predetermined parameter.

If the determined time is larger than a predetermined parameter, the opening of the box is performed locally. If the parameter is smaller than 30 minutes, a verification 60 is performed to determine if the ID of the recipient is a Customs ID, and if not, if it is a carrier ID 70. If so, the country and/or area of the container is matched 80 with the destination, and if a match is found, the container is opened 90. Customs and carriers might have different geographical area validations than regular consignee's have.

If the ID is not a Customs or a Carrier ID, a check 110 is performed to determine if the ID is the ID of the intended recipient (consignee). If this happens to be the case, the location is matched 120 with the intended location, and if so, the box is opened 90.

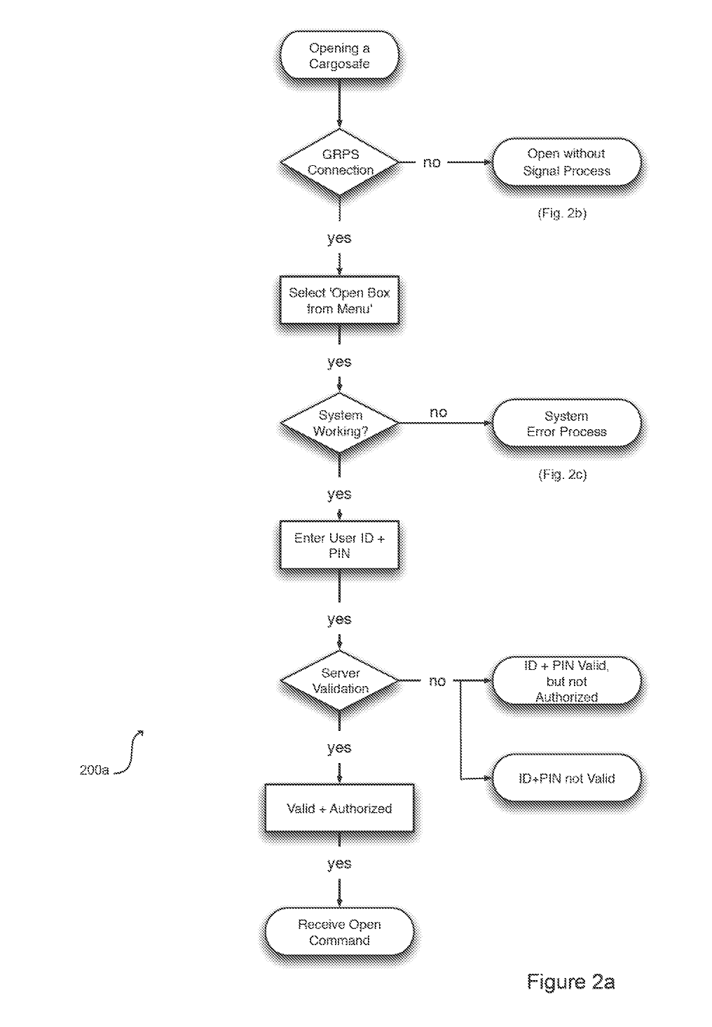

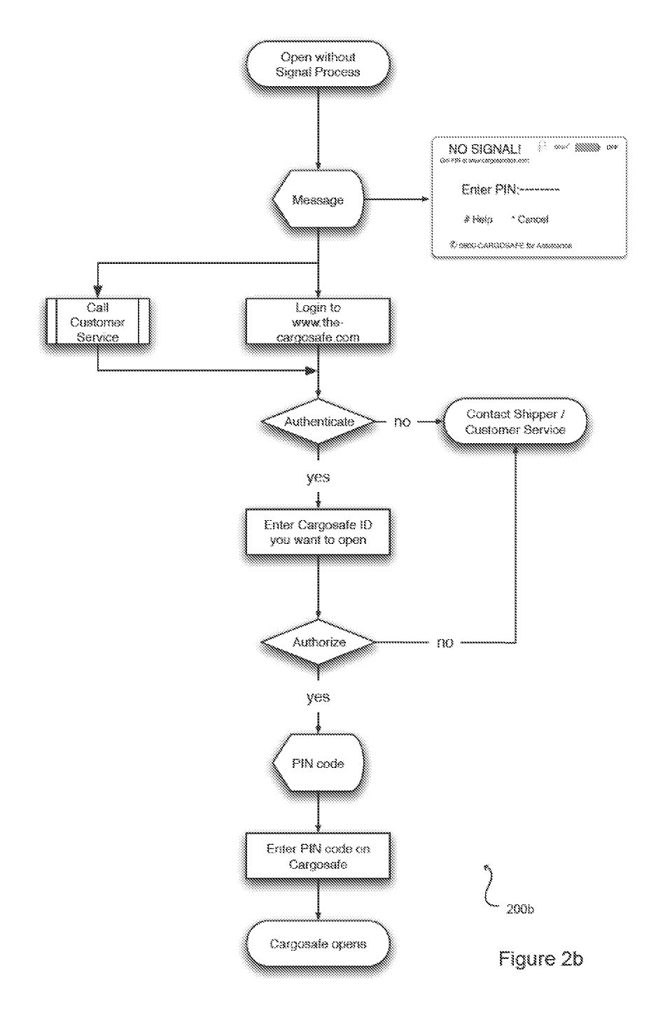

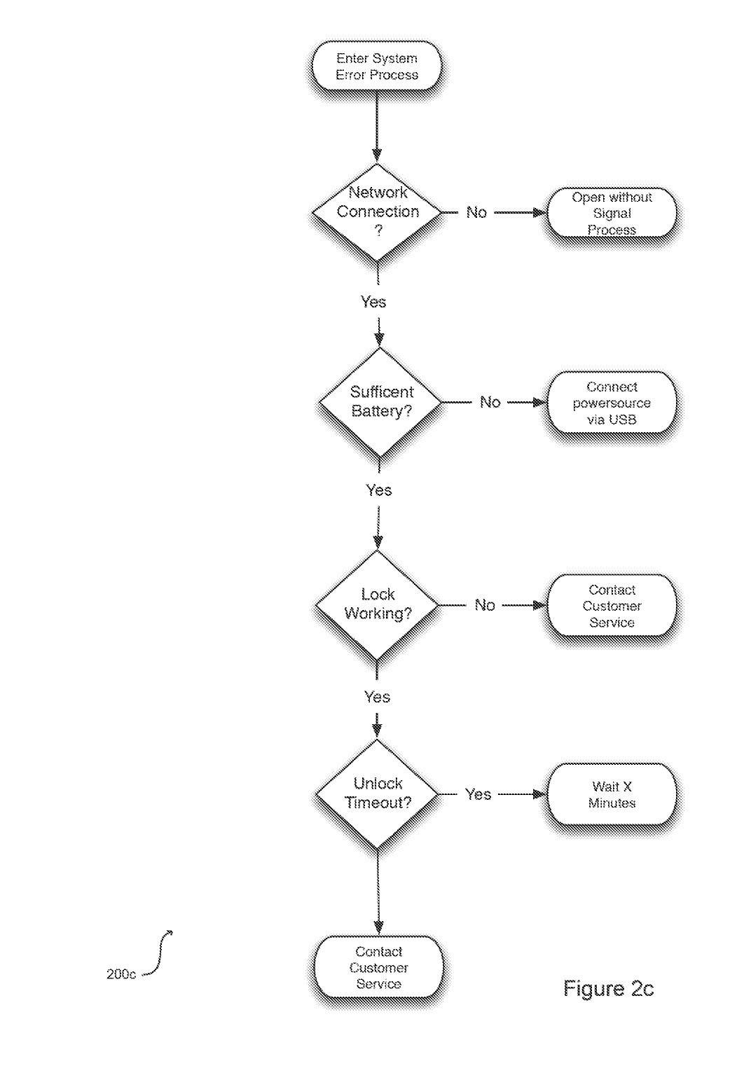

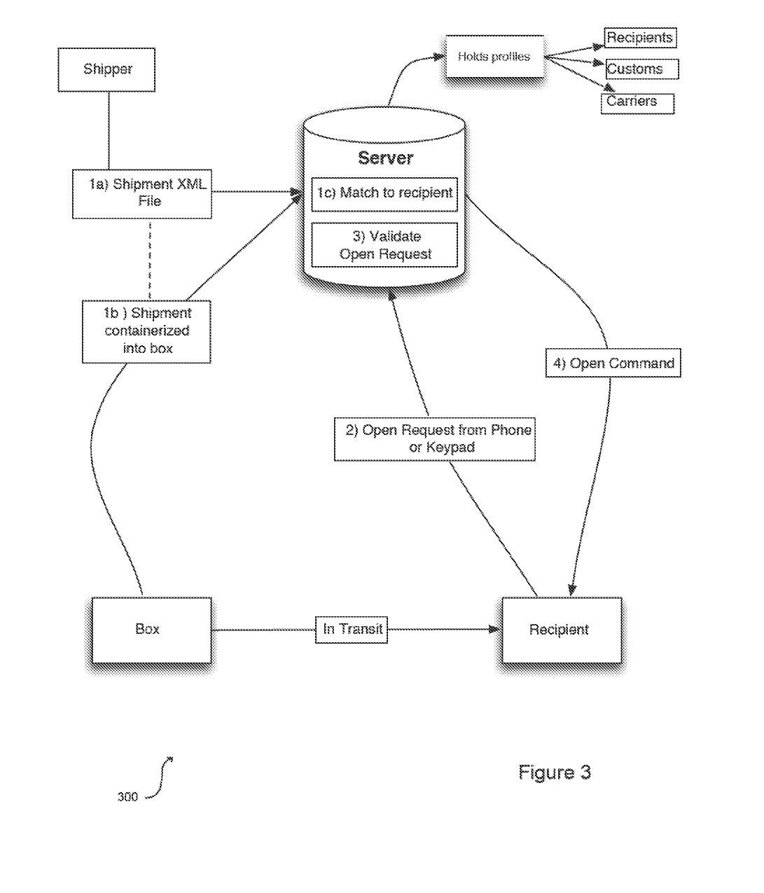

FIGS. 2a-2c show a self-explanatory process flow 200a, 200b and 200c of opening a container according to the invention. In FIG. 2a, Local pincodes are programmed on the Cargosafes when they are assigned to a shipper. They can only be used on the cargosafe when there is no signal. When there is a signal the server has to validate the request by either using the onboard keypad, sms or phone app. FIG. 2c shows the system error process.

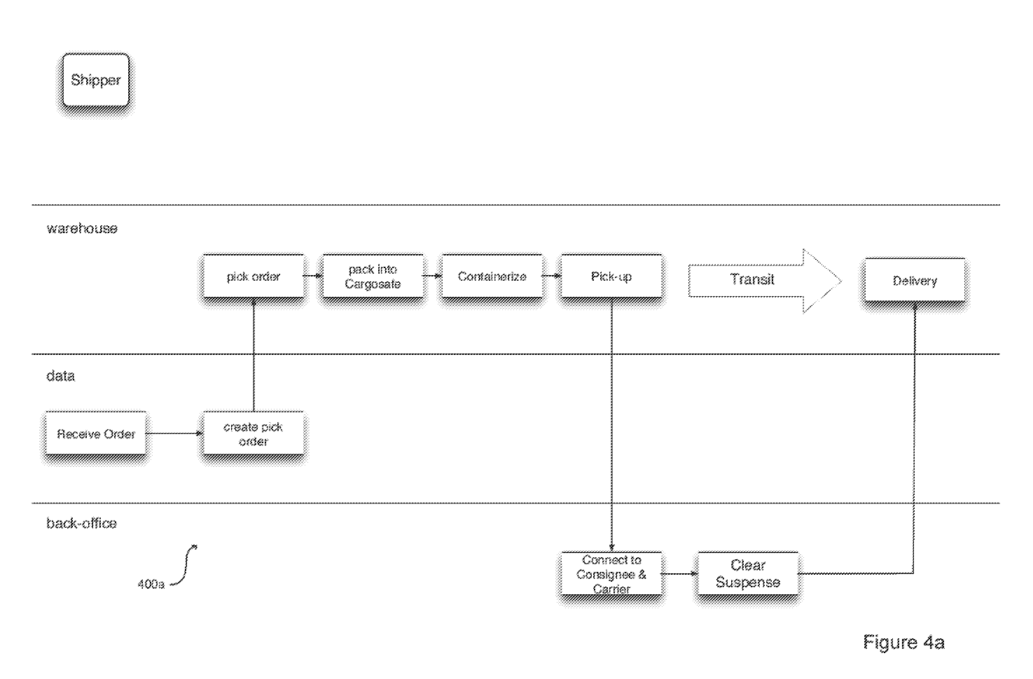

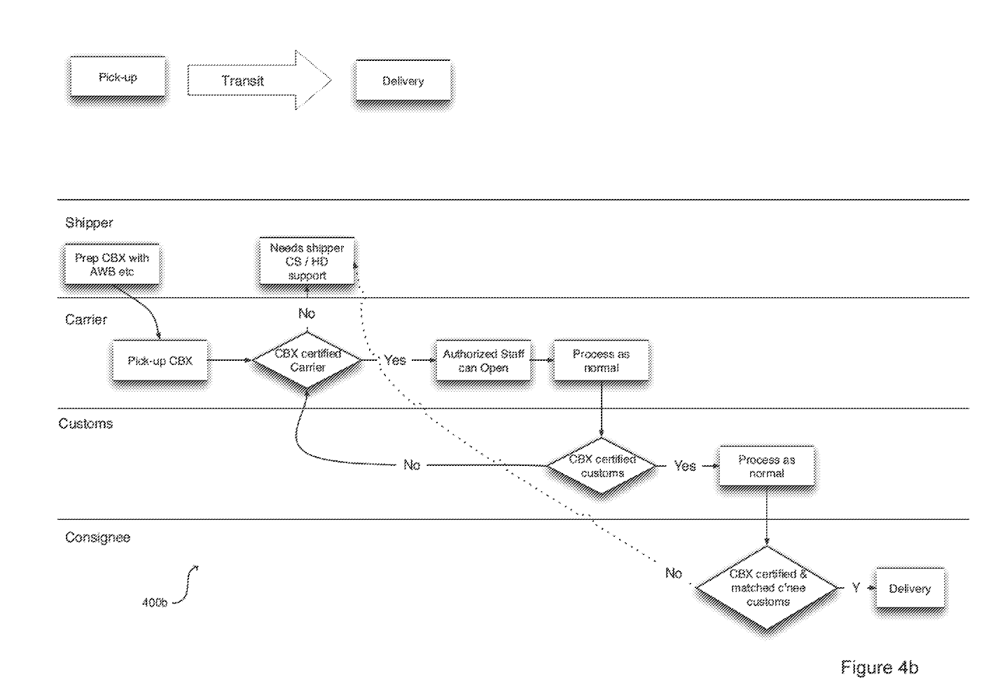

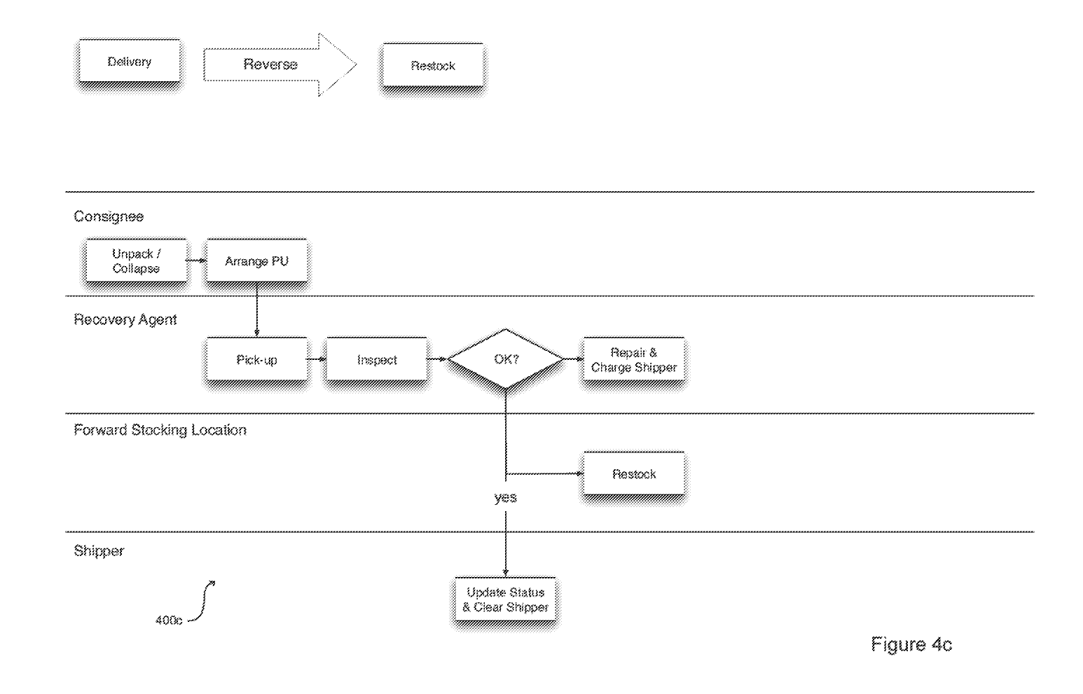

FIG. 3 shows a self-explanatory high-level data process flowchart 300 according to the invention. FIGS. 4a-4c show a self-explanatory high level process flow 400 according to the invention.

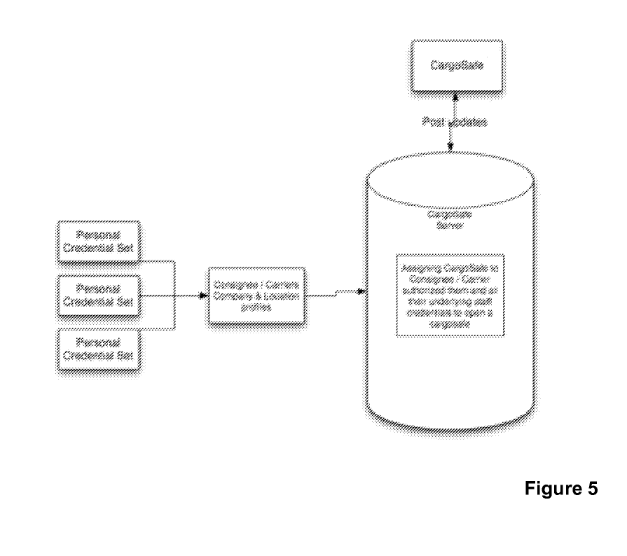

FIG. 5 illustrates a process flow 500, demonstrating how a cargo container connects via the internet to a server. On the server a relationship is maintained between the shipper, the consignee of the shipment and the carrier(s) transporting the cargo container. The Shipper has full control via a webbased interface, or by sending an XML file to the server who is authorized (matched) to open the cargo container.

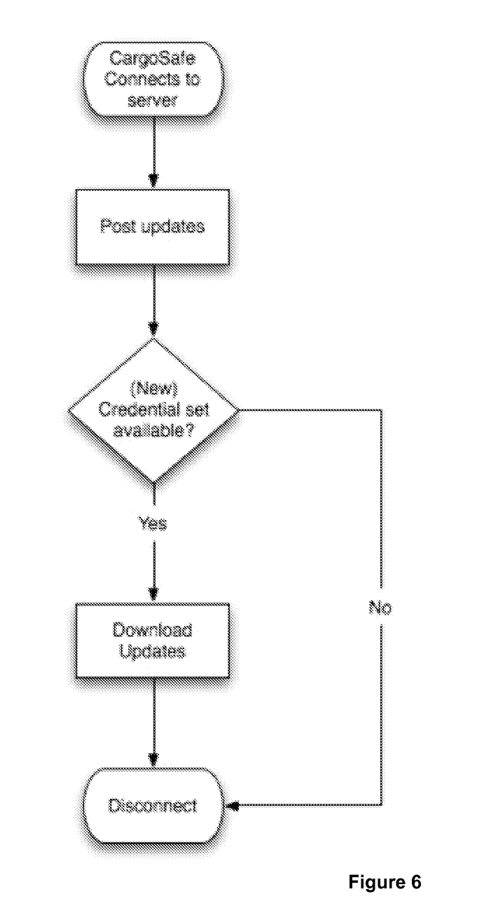

FIG. 6 shows that each time the cargo container connects to the server it will check to see if there are any changes in the profiles of either at the company level or at the underlying staff level belonging to that account. These changes could be for instance a PIN code change of one of the staff members, a staff addition or removal. At the account level, for example, the geographical location where within the unlock codes work can be updated.

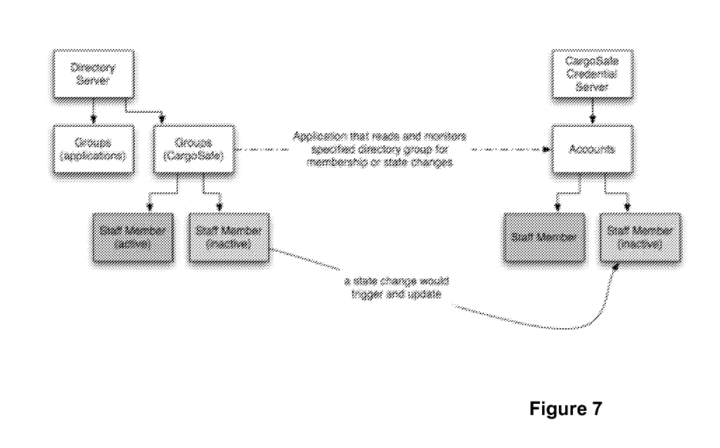

FIG. 7 shows the use of a central server at which consignees and carriers/handlers of containers will be able to create a company account. That company account can hold multiple locations, for instance a retail chain with multiple shops, each of whom need to receive and open containers. Each Location can have multiple staff members that are allowed to open containers assigned (matched) to that companies account. These staff accounts can have timewindows at which time they are able to open containers at that location for that account. For example for part time staff members that only work on certain days or part of the day.

Accounts may then have to maintain separate staff member databases. Staff members will have to be included in the companies own IT Directory for access to email, applications, storage etc. These companies would also have to set-up profiles for these members in a directory to create credentials etc. The invention therefore proposes to integrate staff member databases with directory services such as Open Directory and Active Directory. These are omni present in corporate environments. They manage application access, builing access, e-mail services, LAN access etc. A regular credential set consists of a;
account
location
staff id
pincode

By setting up a group in the Directory Service according to the invention and requiring a membership to that group in order to set-up valid credentials, companies can now manage credentials in one place. In order to be set-up a valid account a user also has to be member of the Directory Group. if a membership to the group is removed or deactivated the associated profile is also deactivated.

What is claimed is:

1. A container for goods transport, comprising:
walls, enclosing a storage space for the goods;
a closable entrance to the storage space;
a lock, for locking respectively unlocking the entrance to the storage space;
means for reading a global destination position for the container in a database;
means for determining an actual global position of the container; and
a controller configured to enable unlocking the lock based on at least the global destination position and the actual global position.

2. The container according to claim 1, wherein the controller is configured to enable unlocking the lock when the actual global position is within a predetermined range of the predetermined global position.

3. The container according to claim 1, further comprising:
input means for an access code, wherein the controller is further configured for enabling locking and unlocking the lock when an access code entered on the input means matches a code stored in the data storage means.

4. The container according to claim 1, wherein the input means comprise at least one of a keypad, a SMS receiver, a means for receiving data through the internet.

5. The container according to claim 1, wherein the controller is configured to receive a request to enable unlocking the lock from a (web)server.

6. The container according to claim 1, wherein the container is configured to increase a frequency on which the actual position is determined, when the container reaches its global destination position.

7. A system for transferring goods, comprising:
at least one container according to claim 1; and
a server, accessible via the internet, and hosting:
a database for storing at least:
an ID for each container, and
a global destination position for each container.

8. The system according to claim 7, wherein the database further comprises a recipient, coupled to a global destination position.

9. The system according to claim 7, wherein at least part of the recipient details are read from an active directory.

10. The system according to claim 7, wherein the database further comprises a recipient type coupled to a recipient.

11. The system according to claim 7, wherein the server comprises a web-interface, accessible for senders of containers, for adding or changing data in the database.

12. The system according to claim 7, wherein the server is configured for receiving a request from a recipient for opening a container, and for forwarding said request to the controller of the respective container.

13. Method A method for transferring goods, comprising:
providing a container with a storage space for goods;
locking the entrance to the storage space;
storing a global destination position for the container in a database;
determining an actual global position of the container; and
unlocking the entrance based on at least the global destination position and the actual global position.

14. The method according to claim 13, wherein unlocking the entrance comprises unlocking the lock when the actual global position is within a predetermined range of the predetermined global position.

15. The method according to claim 14, comprising enabling locking and unlocking the lock when an access code entered on the input means matches a code stored in the data storage means.

16. The method according to claim 13, comprising increasing a frequency on which the actual position is determined, when the container reaches its global destination position.

17. The container according to claim 1, wherein the closable entrance is a door.

18. The container according to claim 3, wherein the access code is a User Code.

19. The container according to claim 3, wherein the access code is a PIN code.
